(19) United States
(12) Patent Application Publication
(10) Pub. No.: US 2026/0181112 A1
(43) Pub. Date: Jun. 25, 2026

(54) PROJECTION DISPLAY DEVICE

(71) Applicant: SEIKO EPSON CORPORATION, Tokyo (JP)

(72) Inventor: Yusuke KOMURO, AZUMINO-SHI (JP)

(73) Assignee: SEIKO EPSON CORPORATION, Tokyo (JP)

(21) Appl. No.: 19/422,485

(22) Filed: Dec. 17, 2025

(30) Foreign Application Priority Data
Dec. 19, 2024 (JP) 2024-223804

(51) Int. Cl. H04N 9/31

(52) U.S. Cl. CPC H04N 9/3152; H04N 9/312; H04N 9/3155

(57) ABSTRACT

A display control circuit controls an optical path shifting element shifts a projection pixel from a first position, which is a stagnation position in a unit period f1, to a second position, which is a stagnation position in a unit period f3, in a unit period f2 in one frame period. The unit period f1 is set as a video pixel A1 corresponding to the first position, the unit period f3 is set as a video pixel A3 corresponding to the second position, and the unit period f2 is set as a video pixel A2 between the video pixels A1 and the A3. A lamp unit is turned on with twice the luminance of the unit periods f1 and f2 in a period from timing t21 to timing t22 in the unit period f2, and is turned off in another period.

The present application is based on, and claims priority from JP Application Serial Number 2024-223804, filed December 19, 2024 the disclosure of which is hereby incorporated by reference herein in its entirety.

### BACKGROUND

### 1. Technical Field

The present disclosure relates to a projection display device.

### 2. Related Art

In a projection display device that projects image light generated by a liquid crystal panel or the like onto a screen or the like, a technique of increasing the resolution in a pseudo manner by an optical path shifting element is known. For example, in a projection display device, a technology is known in which one frame period is divided into a plurality of unit periods, a projection position of one panel pixel in a liquid crystal panel is shifted for each of the plurality of unit periods, and a gradation level designated by pixel data is individually expressed in each unit period (for example, refer to JP-A-2019-39995).

However, in the above technique, in order to increase the resolution, it is necessary to shift the projection position of the panel pixel for each unit period. For example, in a case where four pixel data is expressed by one panel pixel, it is necessary to shift the projection position every four unit periods, and in a case where eight pixel data is expressed, it is necessary to shift the projection position every eight unit periods. Therefore, in order to increase the resolution in a pseudo manner, it is necessary to increase the speed of the shift of the projection position by the optical path shifting element, and there is a problem that the cost of the device increases, the size of the device increases, and the like.

### SUMMARY

In order to solve the above problem, a projection display device according to an aspect of the present disclosure includes: a light source configured to emit light; a liquid crystal panel having a panel pixel and configured to receive light emitted from the light source; an optical path shifting element configured to shift an optical path of projection light emitted from the liquid crystal panel to change a position of a projection pixel projected from the panel pixel; and a display control circuit configured to control the liquid crystal panel and the optical path shifting element. Video data is constituted by pixel data. The display control circuit is configured to cause the optical path shifting element to shift the position of the projection pixel from a first position to a second position in one frame period and supplies, to the panel pixel, a data signal corresponding to a gradation level designated by the pixel data, set pixel data corresponding to the data signal to first pixel data that corresponds to the first position in a period in which the position of the projection pixel is the first position, second pixel data that corresponds to the second position in a period in which the position of the projection pixel is the second position, and third pixel data that is located between the first pixel data and the second pixel data in a period in which the position of the projection pixel is shifted from the first position to the second position via a first section including a third position, and cause the light source to turn off or reduce light in a period in which the position of the projection pixel is from the first position to a start point of the first section, illuminate the projection pixel with a luminance higher than a reduced light in a period in which the position of the projection pixel is in the first section, and turn off or reduce light in a period in which the position of the projection pixel is located between an end point of the first section and the second position.

### BRIEF DESCRIPTION OF THE DRAWINGS

FIG. 1 is a diagram illustrating a projection display device according to a first embodiment.

FIG. 2 is a block diagram illustrating the configuration of the projection display device.

FIG. 3 is a block diagram illustrating an electrical configuration of a liquid crystal panel in the projection display device.

FIG. 4 is a diagram illustrating a configuration of a pixel circuit in a liquid crystal panel.

FIG. 5 is a diagram illustrating a relationship between video pixels and panel pixels in the projection display device.

FIG. 6 is a diagram illustrating a relationship between one frame period and a unit period in the projection display device.

FIG. 7 is a diagram illustrating projection positions in one frame period.

FIG. 8 is a diagram illustrating operations of the optical path shifting element and the lamp unit in one frame period.

FIG. 9 is a diagram illustrating panel pixels visually recognized by a viewer in one frame period.

FIG. 10 is a diagram illustrating a relationship between the video pixels and the panel pixels in the second embodiment.

FIG. 11 is a diagram illustrating operations of the optical path shifting element and the lamp unit in one frame period in the second embodiment.

FIG. 12 is a diagram illustrating panel pixels visually recognized by an observer in one frame period in the second embodiment.

FIG. 13 is a diagram illustrating a relationship between video pixels and panel pixels in the third embodiment.

FIG. 14 is a diagram illustrating operations of the optical path shifting element and the lamp unit in one frame period in the third embodiment.

FIG. 15 is a diagram illustrating panel pixels visually recognized by an observer in one frame period in the third embodiment.

FIG. 16 is a diagram illustrating a relationship between the video pixels and the panel pixels in the comparative example.

FIG. 17 is a diagram illustrating operations of the optical path shifting element and the lamp unit in one frame period in the comparative example.

FIG. 18 is a diagram illustrating panel pixels visually recognized by an observer in one frame period in a comparative example.

### DESCRIPTION OF EMBODIMENTS

Hereinafter, a projection display device according to an embodiment will be described with reference to the drawings. In the drawings, the dimensions and scales of the respective parts are appropriately different from the actual ones. In addition, since the embodiments described below are preferred specific examples, various technically preferable limitations are added, but the scope of the present disclosure is not limited to these embodiments unless there is a description to limit the present disclosure in the following description.

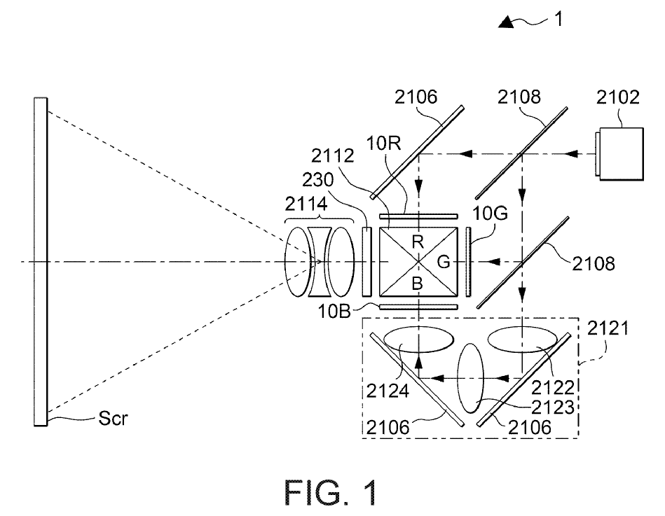

FIG. 1 is a diagram illustrating an optical configuration of a projection display device 1 according to a first embodiment. As illustrated in the figure, the projection display device 1 includes liquid crystal panels 10R, 10G, and 10B. A lamp unit 2102 including a white light source such as a laser is provided inside the projection display device 1. The projection light emitted from the lamp unit 2102 is separated into three primary colors of red (R), green (G), and blue (B) by three mirrors 2106 and two dichroic mirrors 2108 disposed inside the projector. Among these, the R color light is incident on the liquid crystal panel 10R, the G color light is incident on the liquid crystal panel 10G, and the B color light is incident on the liquid crystal panel 10B.

Since the optical path of B is longer than the optical path of R and the optical path of G, it is necessary to prevent a loss in the optical path of B. Therefore, a relay lens system 2121 including an incidence lens 2122, a relay lens 2123, and an emission lens 2124 is provided in the optical path of B.

The liquid crystal panel 10R has a plurality of pixel circuits as will be described later. Each of the plurality of pixel circuits includes a liquid crystal element. The liquid crystal element of the liquid crystal panel 10R is driven based on the data signal corresponding to R, and has a transmittance corresponding to the voltage of the data signal.

Therefore, by individually controlling the transmittances of the liquid crystal elements based on the data signal corresponding to R, a transmission image of R is generated in the liquid crystal panel 10R. Similarly, in the liquid crystal panel 10G, a G transmission image is generated based on the G data signal, and in the liquid crystal panel 10B, a B transmission image is generated based on the B data signal.

The transmission images of the respective colors generated by the liquid crystal panels 10R, 10G, and 10B are incident on the dichroic prism 2112 from three directions. In the dichroic prism 2112, the R and B light beams are refracted at 90 degrees, while the G light beam travels straight. Therefore, the dichroic prism 2112 combines the images of the respective colors. The combined image formed by the dichroic prism 2112 is incident on the projection lens 2114 via the optical path shifting element 230.

The projection lens 2114 enlarges and projects the combined image via the optical path shifting element 230 on the screen Scr.

The optical path shifting element 230 shifts the optical path of light emitted from the dichroic prism 2112. Specifically, the optical path shifting element 230 shifts the combined image projected on the screen Scr in the left-rightward direction and/or the up-down direction with respect to the projection surface. That is, in the first embodiment, the optical path shifting element 230 is a two axis shift type.

The transmission images by the liquid crystal panels 10R and 10B are projected after being reflected by the dichroic prism 2112, whereas the image transmitted through the liquid crystal panel 10G is projected after traveling straight. Therefore, the transmission images by the liquid crystal panels 10R and 10B are in a left-right inverted relationship with respect to the transmission image of the liquid crystal panel 10G.

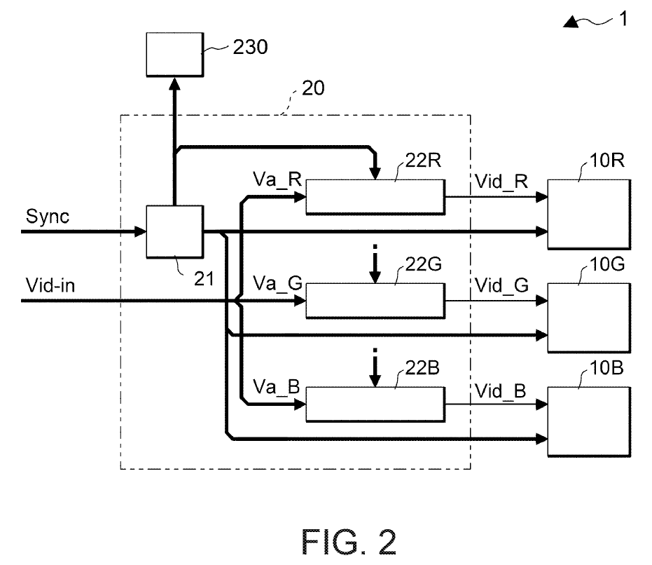

FIG. 2 is a block diagram illustrating an electrical configuration of the projection display device 1. As illustrated in FIG. 1, the projection display device 1 includes a display control circuit 20, the liquid crystal panels 10R, 10G, and 10B, and the optical path shifting element 230.

A video data Vid-in is supplied from a higher-level device such as a host device (not illustrated) in synchronization with a synchronization signal Sync. The video data Vid-in designates gradation level of a pixel constituting one frame period of a video with, for example, 8 bits for each of RGB.

A pixel of an image designated by the video data Vid-in is denoted as a video pixel, and data designating gradation level of the video pixel is denoted as pixel data, but the video pixel and the pixel data may be described without being particularly distinguished from each other. Further, a pixel of an image before or after combination by the liquid crystal panels 10R, 10G, or 10B is referred to as a panel pixel. The position of the panel pixel shifted by the optical path shifting element 230 and projected on the screen Scr is referred to as the position of the projection pixel or the projection position.

In the liquid crystal panels 10R, 10G, and 10B, the panel pixels are arranged in a matrix in plan view. In the embodiment, the arrangement of the video pixels designated by the video data Vid-in is, for example, three times in the vertical direction and three times in the horizontal direction compared to the arrangement of the panel pixels by the liquid crystal panels 10R, 10G, or 10B.

In the embodiment, the color image projected on the screen Scr is expressed by combining the respective transmission images of the liquid crystal panels 10R, 10G, and 10B. Therefore, the minimum unit of a color image can be divided into a red sub-pixel by the liquid crystal panel 10R, a green sub-pixel by the liquid crystal panel 10G, and a blue sub-pixel by the liquid crystal panel 10B. However, when it is not necessary to specify the color of the sub-pixels in the liquid crystal panels 10R, 10G, and 10B, or when only brightness is concerned, the sub-pixels do not need to be referred to as sub-pixels. Therefore, in the present description, the display unit in the liquid crystal panels 10R, 10G, and 10B is also referred to as a panel pixel.

The synchronization signal Sync includes a vertical synchronization signal for instructing the start of vertical scanning of the video data Vid-in, a horizontal synchronization signal for instructing the start of horizontal scanning, and a clock signal indicating the timing of one video pixel in the video data Vid-in.

The display control circuit 20 includes a processing circuit 21 and conversion circuits 22R, 22G, and 22B.

The processing circuit 21 controls the conversion circuits 22R, 22G, and 22B, the liquid crystal panels 10R, 10G, and 10B, and the optical path shifting element 230 for each unit period described later, based on the synchronization signal Sync. The optical path shifting element 230 shifts the projection position under the control of the processing circuit 21.

In the video data Vid-in supplied from the higher-level device, the R component is denoted as video data Va_R, the G component is denoted as video data Va_G, and the B component is denoted as video data Va_B.

The conversion circuit 22R temporarily stores the video data Va_R of the video data Vid-in for one or more frame periods in an internal buffer, reads the video data corresponding to a unit period, converts the video data into the analog voltage data signal Vid_R, and supplies to the liquid crystal panel 10R.

The conversion circuits 22G and 22B are different from the conversion circuit 22R only in the color components of the video data to be converted, and the other components are the same as those of the conversion circuit 22R. That is, the conversion circuit 22G converts the video data Va_G corresponding to the unit period into the video data of the analog voltage and supplies the data signal Vid_G to the liquid crystal panel 10G, and the conversion circuit 22B converts the video data Va_B corresponding to the unit period into the video data of the analog voltage and supplies the data signal Vid_B to the liquid crystal panel 10B.

Next, the liquid crystal panels 10R, 10G, and 10B will be described. The liquid crystal panels 10R, 10G, and 10B are structurally the same, except for the colors of incident light, that is, the wavelengths. Therefore, when the liquid crystal panels 10R, 10G, and 10B are generally described without specifying color, the reference numeral will be 10.

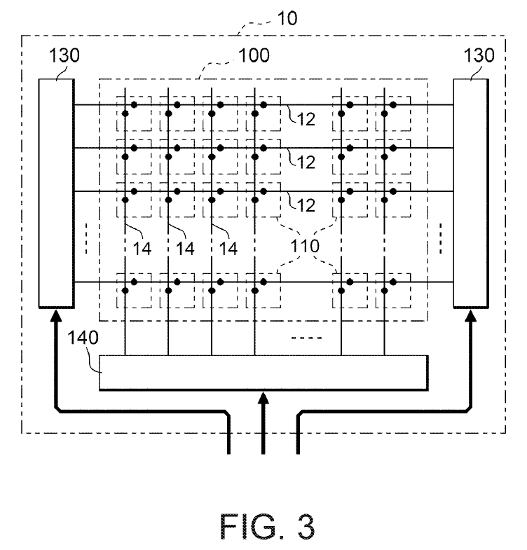

FIG. 3 is a block diagram illustrating an electrical configuration of the liquid crystal panel 10. The liquid crystal panel 10 is provided with a scanning line drive circuit 130 and a data line drive circuit 140 at the periphery of the display region 100.

In the display region 100, the pixel circuits 110 are arranged in a matrix. Specifically, in the display region 100, a plurality of scanning lines 12 are provided to extend in the horizontal direction in the drawing, and a plurality of data lines 14 are provided to extend in the vertical direction and to be electrically insulated from the scanning lines 12. The pixel circuits 110 are provided in a matrix corresponding to the intersections of the plurality of scanning lines 12 and the plurality of data lines 14.

When the number of the scanning lines 12 is m and the number of the data lines 14 is n, the pixel circuits 110 are arranged in a matrix of m rows in the vertical direction and n columns in the horizontal direction. Both m and n are integers of 2 or more. In the scanning lines 12 and the pixel circuits 110, in order to distinguish the rows of the matrix, the rows may be referred to as 1, 2, 3,..., (m-1), and m rows in order from the top in the drawing. Similarly, in the data lines 14 and the pixel circuits 110, in order to distinguish the columns of the matrix, the columns may be referred to as 1, 2, 3,..., (n-1), and n columns in order from the left in the drawing.

The scanning line drive circuit 130 selects the scanning lines 12 one by one in the order of, for example, the first, second, third,..., and m-th rows under the control of the display control circuit 20, and sets the scanning signal to the selected scanning line 12 to the H level. The scanning line drive circuit 130 sets the scanning signals to the scanning lines 12 other than the selected scanning line 12 to the L level.

The data line drive circuit 140 latches the data signals for one row supplied from the conversion circuit of the corresponding color among the conversion circuits 22R, 22G, and 22B, and outputs the data signals to the pixel circuits 110 positioned on the scanning line 12 via the data lines 14 in a period in which the scanning signal to the scanning line 12 is at the H level.

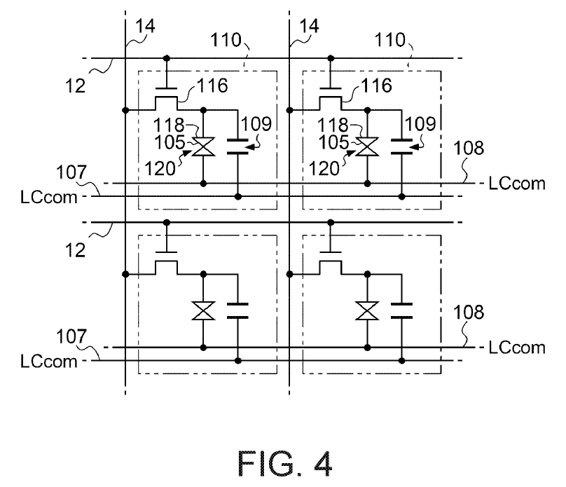

FIG. 4 is a diagram illustrating an equivalent circuit of a total of four pixel circuits 110 in two rows and two columns corresponding to intersections of two adjacent scanning lines 12 and two adjacent data lines 14.

As illustrated in the figure, the pixel circuit 110 includes a transistor 116 and a liquid crystal element 120. The transistor 116 is, for example, an n-channel thin film transistor. In the pixel circuit 110, a gate node of the transistor 116 is connected to the scanning line 12, a source node thereof is connected to the data line 14, and a drain node thereof is connected to the pixel electrode 118 having a square shape in plan view.

As is well known, the liquid crystal panel 10 has a configuration in which an element substrate on which a transistor 116, a pixel electrode 118, and the like are formed and a counter substrate on which a common electrode 108 is formed have electrode forming surfaces facing each other and liquid crystal 105 is sealed therebetween.

Therefore, a liquid crystal element 120 in which the liquid crystal 105 is sandwiched between the pixel electrode 118 and the common electrode 108 is formed for each pixel circuit 110. Note that a voltage LCcom is applied to the common electrode 108.

A storage capacitor 109 is provided in parallel with the liquid crystal element 120. One end of the storage capacitor 109 is connected to the pixel electrode 118, and the other end is connected to the capacitor line 107. A temporally constant voltage, for example, a voltage LCcom which is the same as the voltage applied to the common electrode 108, is applied to the capacitor line 107.

In the scanning line 12 in which the scanning signal is set to the H level, the transistor 116 of the pixel circuit 110 provided corresponding to the scanning line 12 is set to the ON state. Since the data line 14 and the pixel electrode 118 are electrically connected to each other by the ON state of the transistor 116, the data signal supplied to the data line 14 reaches the pixel electrode 118 via the transistor 116 in the ON state. When the scanning line 12 is at the L level, the transistor 116 is in the OFF state, but the voltage of the data signal that has reached the pixel electrode 118 is held by the capacitive property of the liquid crystal element 120 and the storage capacitor 109.

As is well known, in the liquid crystal element 120, the alignment of liquid crystal molecules changes in accordance with an electric field generated by the pixel electrode 118 and the common electrode 108. Therefore, the liquid crystal element 120 has a transmittance corresponding to the effective value of the applied voltage.

Note that the region of the liquid crystal element 120 that functions as a panel pixel, that is, the region having a transmittance corresponding to the effective value of the voltage, is a region where the pixel electrode 118 and the common electrode 108 overlap each other when the liquid crystal panel 10 is viewed in plan view. Since the pixel electrode 118 is square in plan view, the region functioning as a panel pixel is also square in plan view.

In the present embodiment, the liquid crystal 105 is a vertical alignment (VA) type, and a normally black mode is set in which the transmittance is the lowest when the applied voltage to the liquid crystal element 120 is zero, and the transmittance increases as the applied voltage increases.

In the unit period, the operation of supplying the positive polarity data signal to the pixel electrode 118 of the liquid crystal element 120 is executed in the order of the first, second, third,..., and m-th rows, and then the operation of supplying the negative polarity data signal is executed in the same order of the first, second, third,..., and m-th rows.

Accordingly, each of the liquid crystal elements 120 of the pixel circuits 110 arranged in m rows and n columns is AC-driven with the positive polarity and the negative polarity for each unit period, and has a transmittance corresponding to the voltage of the data signal. Such generation of the transmission image is executed for each of RGB, and thus a color image obtained by combining RGB is projected on the screen Scr.

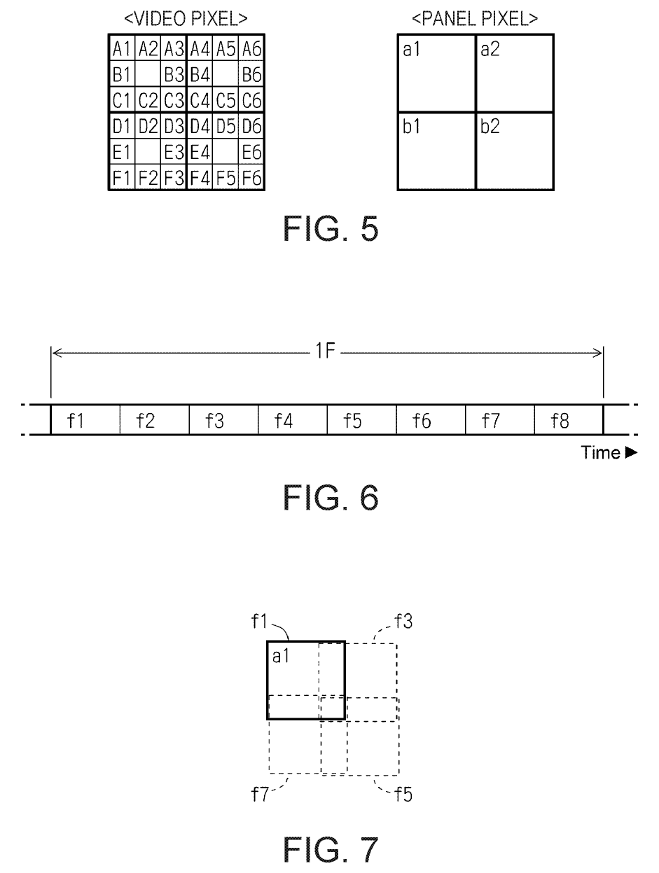

FIG. 5 is a diagram for explaining a correspondence relationship between video pixels and panel pixels in the projection display device 1.

Specifically, in FIG. 5, the left side is a diagram illustrating a part of the arrangement of the video pixels indicated by the video data Vid-in, and the right side is a diagram illustrating the arrangement of the panel pixels corresponding to the arrangement of the video pixels in the left column.

In the array on the left side, in order to distinguish the video pixels in the image indicated by the video data Vid-in, for convenience sake, the following numerals are assigned: A1 to A6 in the first row, B1, B3, B4, B6 in the second row, C1 to C6 in the third row, D1 to D6 in the fourth row, E1, E3, E4, E6 in the fifth row, and F1 to F6 in the sixth row. Similarly, in the arrangement on the right side, in order to distinguish the panel pixels, for convenience, following numerals are assigned: a1 and a2 in the first row and b1 and b2 in the second row.

In the present embodiment, white portions to which no reference numerals are given in the arrangement of the video pixels means video pixels that are not represented by the panel pixel. In other words, this means that the video pixel of which the center of white portion of the 3 × 3 video pixels in the video data Vid-in is not expressed in the present embodiment. “The image pixel is expressed by the panel pixel" means that the liquid crystal element 120 of the panel pixel has a transmittance corresponding to the gradation level (pixel data) of the video pixel.

FIG. 6 is a diagram for explaining a relationship between a frame (1F) period and unit periods in the projection display device 1 according to the first embodiment. As illustrated in the figure, in the present embodiment, one frame (1F) period is divided into eight unit periods. For convenience, the eight unit periods are denoted by reference numerals f1, f2, f3,..., f8 in order of time.

One frame (1F) period is a period in which one frame of an image indicated by the video data Vid-in from the higher-level device is supplied, and is 16.7 milliseconds of one cycle in a case where the frequency of the vertical synchronization signal included in the synchronization signal Sync is 60Hz. In this case, the length of each unit period is 2.08 milliseconds, which is 1/8 of the length of one frame period.

The unit period is a period for allowing the user to visually recognize an image, which is obtained by reducing the resolution of the images of one frame (1F) period designated by the video data Vid-in to 1/9, as a combined image by the liquid crystal panels 10R, 10G, and 10B.

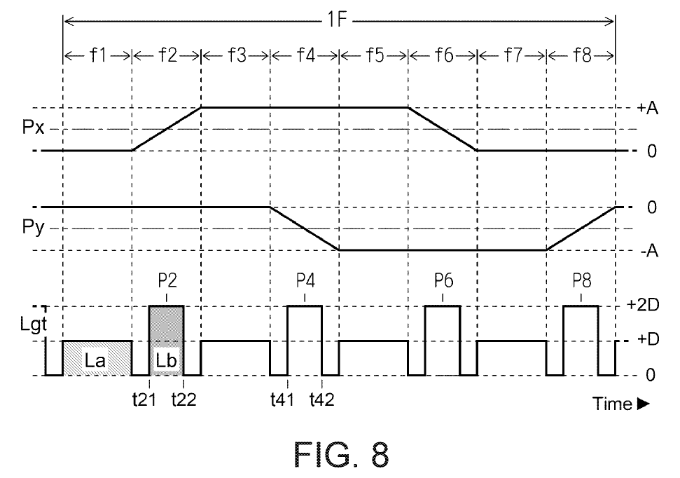

FIG. 7 is a diagram illustrating the projection positions of the optical path shifting element 230 in the unit periods f1 to f8 of one frame (F1) period. Further, FIG. 8 is a diagram for explaining the control of the optical path shifting device 230 and the lamp unit 2102 by the processing circuit 21 in the unit periods f1 to f8.

As described above, the optical path shifting element 230 shifts, with respect to the projection surface to the screen Scr, the position of the projection pixel of the combined image along the left-rightward direction, that is, the X direction and the direction opposite to the X direction, and the up-down direction, that is, the Y direction and the direction opposite to the Y direction. In the optical path shifting element 230, the shift along the X axis is controlled according to the control signal Px, and the shift along the Y axis is controlled according to the control signal Py.

When the levels of the control signals Px and Py are zero, the position of the projection pixel is the reference position in the unit period f1. The reference position is indicated by a black frame of a thick line in FIG. 7.

When the level of the control signal Px is +A, the optical path shifting element 230 shifts the position of the projection pixel by 2/3 pixel in terms of panel pixels from the reference position in the rightward direction with respect to the projection surface, and, when the level of the control signal Py is -A, shifts the projection position by 2/3 pixel in terms of panel pixels from the reference position in the downward direction with respect to the projection surface.

The projection position of the optical path shifting element 230 is controlled by the processing circuit 21.

In the unit period f1, as illustrated in FIG. 8, both the control signals Px and Py are constant at zero. Therefore, the projection position stagnates at the reference position in the unit period f1.

A period in which the projection position stagnates, such as the unit period f1, may be referred to as a stagnation period. The panel pixel a1 expresses the video pixel A1 at the reference position in the unit period f1, which is a stagnation period.

The control signal Px starts to rise from zero at the start timing of the unit period f2 and reaches +A at the end timing of the unit period f2. The control signal Py is constant at zero in the unit period f2. Therefore, at the start timing of the unit period f2, the position of the projection pixel starts to shift from the reference position in the rightward direction in the drawing and, at the end timing of the unit period f2, reaches a position shifted from the reference position in the rightward direction by 2/3 pixels in terms of panel pixels.

A period in which the projection position is shifted, such as the unit period f2, may be referred to as a shift period. The panel pixel a1 expresses the video pixel A2 in the unit period f2, which is a shift period.

In the unit period f3, the control signal Px is +A, the control signal Py is zero, and both are constant. Therefore, in the unit period f3, the position of the projection pixel stagnates at a position shifted by 2/3 pixels in terms of panel pixels from the reference position in the rightward direction. The panel pixel a1 expresses the video pixel A3 in the unit period f3, which is a stagnation period.

The control signal Px is constant at +A in the unit period f4. The control signal Py starts to decrease from zero at the start timing of the unit period f4 and reaches -A at the end timing of the unit period f4. Therefore, at the start timing of unit period f4, the projection position starts to shift in the downward direction in the drawing from the stagnation position of unit period f3 and, at the end timing of the unit period f4, reaches a position shift in the downward direction from the stagnation position of the unit period f3 by 2/3 pixels in terms of panel pixels. The panel pixel a1 expresses the video pixel B3 in the unit period f4, which is a shift period.

In the unit period f5, the control signal Px is +A and the control signal Py is -A, and both are constant. Therefore, in the unit period f5, the position of the projection pixel stagnates at a position shift in the downward direction from the stagnation position in the unit period f3 by 2/3 pixels in terms of panel pixels. The panel pixel a1 expresses the video pixel C3 in the unit period f5, which is a stagnation period.

The control signal Px starts to decrease from +A at the start timing of the unit period f6 and reaches zero at the end timing of the unit period f6. The control signal Py is constant at -A in the unit period f6. Therefore, at the start timing of the unit period f6, the projection position starts to shift in the leftward direction in the drawing from the stagnation position of unit period f5 and, at the end timing of the unit period f6, reaches a position shifted in the leftward direction from the stagnation position of the unit period f5 by 2/3 pixels in terms of panel pixels. The panel pixel a1 expresses the video pixel C2 in the unit period f6, which is a shift period.

In the unit period f7, the control signal Px is zero, the control signal Py is -A, and both are constant. Therefore, in the unit period f7, the projection position stagnates at a position shifted by 2/3 pixels in terms of panel pixels in the leftward direction from the stagnation position in the unit period f5. The panel pixel a1 expresses the video pixel C1 in the unit period f7.

The control signal Px is constant at zero in the unit period f8. The control signal Py rises from -A at the start timing of the unit period f8 and reaches zero at the end timing of the unit period f8. Therefore, at the start timing of unit period f8, the projection position starts to shift upward in the drawing from the stagnation position of unit period f7 and, at the end timing of the unit period f8, returns to a position shifted upward from the position of the unit period f7 by 2/3 pixels in terms of panel pixels, that is, returns to the reference position. The panel pixel a1 expresses the video pixel B1 in the unit period f8, which is a shift period.

In the present embodiment, the control signal Lgt is constant at +D in the unit periods f1, f3, f5, and f7 in which the position of the projection pixel is stagnant. The value is zero immediately after the start of the unit periods f2, f4, f6, and f8, which are shift periods, but then changes from zero to +2D, becomes constant for a while, and becomes zero again before the end.

Specifically, in the unit period f2, the control signal Lgt is at zero from the start timing to the timing t21, is at +2D from the timing t21 to the timing t22, and is at zero from the timing t22 to the end timing. In terms of the unit period f4, the control signal Lgt is at zero from the start timing to the timing t41, is at +2D from the timing t41 to the timing t42, and is at zero from the timing t42 to the end timing.

The product of the period length in the unit periods f1, f3, f5, and f7 multiplied by +D, which is the level of the control signal Lgt, that is, the area hatched in FIG. 8, is denoted as La. The product of the period length in the unit periods f2, f4, f6 and f8 multiplied by +2D, which is the level of the control signal Lgt, that is, the area hatched in the drawing, is denoted as Lb.

In the present embodiment, in the unit periods f2, f4, f6, and f8, the period length in which the level of the control signal Lgt is +2D is 1/2 of the period length of the unit period. Therefore, the area La and the area Lb are equal to each other.

In the unit periods f2, f4, f6, and f8, the level of the control signal Lgt becomes +2D, and thus the luminance of the light emitted from the lamp unit 2102 is instantaneously increased, but the luminance of the temporal mean value is substantially the same in the unit periods f1 to f8.

In FIG. 8, the period center of unit period f2, which is a shift period, is denoted as P2 for convenience. Similarly, the period centers of the unit periods f4, f6, and f8, which are shift periods, are denoted as P4, P6, and P8, respectively.

In order to describe the superiority of the projection display device 1 according to the present embodiment, a projection display device according to a comparative example will be described.

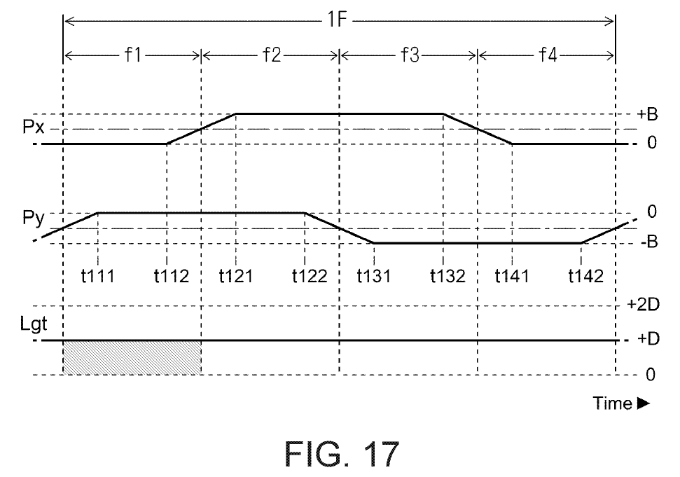

FIG. 16 is a diagram for explaining a correspondence relationship between video pixels and panel pixels in a projection display device according to a comparative example. FIG. 17 is a diagram for explaining the projection position and the control of the lamp unit 2102 in the unit periods f1 to f4 in the comparative example.

In the comparative example, as illustrated in FIG. 17, one frame (1F) period is divided into four periods of f1, f2, f3, and f4 in the order of time.

In the comparative example, when the level of the control signal Px is +B, the optical path shifting element 230 shifts the position of the projection pixel in the rightward direction across the projection surface by 1/2 pixel, in terms of panel pixels, from the reference position and, when the level of the control signal Py is -B, shifts the projection position downward direction across the projection surface by 1/2 pixel, in terms of panel pixels, from the reference position.

In the comparative example, in the unit period f1, the control signal Px starts to rise from zero at the timing t112 before the end timing, and reaches +B/2 at the end timing. In the unit period f1, the control signal Py rises from -B/2 at the start timing and reaches zero at the timing t111 after the start timing. Therefore, in the period from the timing t111 to the timing t112 in the unit period f1, the position of the projection pixel stagnates at the reference position. In the comparative example, the panel pixel a1 expresses the video pixel A1 in the unit period f1 as illustrated in FIG. 16.

In the comparative example, in the unit period f2, the control signal Px rises from +B/2 at the start timing and reaches +B at the timing t121 after the start timing. In the unit period f2, the control signal Py starts to decrease from zero at the timing t122 before the end timing, and reaches -B/2 at the end timing.

Therefore, in the period from the timing t121 to the timing t122 in the unit period f2, the position of the projection pixel stagnates at a position shifted in the rightward direction by 1/2 pixel, in terms of panel pixels, from the reference position. In the comparative example, the panel pixel a1 expresses the video pixel A2 in the unit period f2.

In the comparative example, in the unit period f3, the control signal Px starts to decrease from +B at the timing t132 before the end timing, and reaches +B/2 at the end timing. In the unit period f3, the control signal Py continuously decrease from -B/2 at the start timing, and reaches -B at the timing t131 after the start timing. Therefore, in the period from the timing t131 to the timing t132 in the unit period f3, the position of the projection pixel stagnates at a position shifted in the downward direction from the stagnation position of the unit period f2 by 1/2 pixel, in terms of panel pixels. In the comparative example, the panel pixel a1 expresses the video pixel B2 in the unit period f3.

In the comparative example, in the unit period f4, the control signal Px decreases from +B/2 at the start timing, and reaches zero at the timing t141 after the start timing. In the unit period f4, the control signal Py starts to rise from zero at the timing t142 before the end timing, and reaches -B/2 at the end timing. In the comparative example, the panel pixel a1 expresses the video pixel B1 in the unit period f4.

In the comparative example, the control signal Lgt is constant at the level +D.

In the liquid crystal panel 10 of the comparative example and the embodiment, the transmissive region serving as the panel pixel is square in plan view, but in practice, a microlens is often provided to increase the light transmission efficiency. When the microlens is provided, the panel pixel is visually recognized as a circular shape that is reduced in light from the center toward the periphery, rather than a square shape with respect to the projection surface.

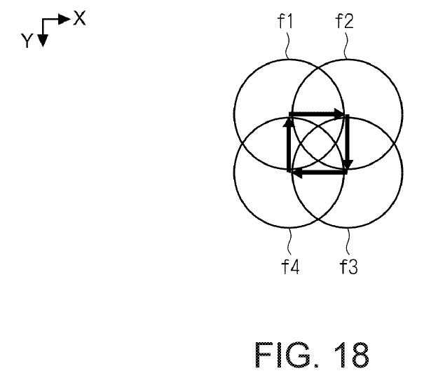

FIG. 18 is a diagram illustrating panel pixels visually recognized by an observer in a stagnation periods of the unit periods f1 to f4 in the comparative example.

In the comparative example, one panel pixel expresses four video pixels in the order of the unit periods f1 to f4, and thus, it seems that the resolution is enhanced in a pseudo manner. However, in the comparative example, the position of the projection pixel shifts every unit period from f1 to f4. Therefore, if a configuration in which one panel pixel expresses eight video pixels is assumed using the technique of the comparative example, it is necessary to shift the projection position every eight unit periods, and for this purpose, the optical path shifting element needs to be driven at a high speed.

In the comparative example, the position of the projection pixel is shifted while the luminance of the lamp unit 2102 is kept constant, and therefore, the video pixel expressed in the shift period is visually recognized in a state of being superimposed on the video pixel visually recognized while the projection position is stagnant. Therefore, in the comparative example, in the shift period, the video pixels are visually recognized in a blurred state at the projection position that should not be visually recognized, which is likely to lead to a decrease in display quality.

In contrast to the comparative example, according to the first embodiment, in unit periods f1, f3, f5 and f7 in which the projection position is stagnant, the panel pixel a1 expresses the video pixels as A1, A3, C3 and C1 in this order.

In the unit period f2, which is a shift period, the panel pixel a1 expresses the video pixel A2, but immediately after the start of the unit period f2, the panel pixel a1 is close to the stagnation position of the unit period f1, and immediately before the end of the unit period f2, the panel pixel is close to the stagnation position of the unit period. f3 However, in the present embodiment, the lamp unit 2102 is in the off state during a period from the start timing to timing t21 of the unit period f2 and from the timing t22 to the end timing of the unit period f2. Therefore, the video pixel A2, which expresses the panel pixel a1, is not visually recognized by the observer in a case where the position of the projection pixel is in a state close to the stagnation position of the unit period f1 and a state close to the stagnation position of the unit period f3.

On the other hand, the period center P2 of the unit period f2 is a middle point between the stagnation position of the unit period f1 and the stagnation position of the unit period f3 in the projection position and, in addition, the lamp unit 2102 increases the light. Therefore, the video pixel A2, which expresses the panel pixel a1, in the unit period f2 is visually recognized by the observer at the position of the unit period f1 and at the substantially middle position of the unit period f3.

Since the area La in the unit period f1 and the area Lb in the unit period f2 are equal to each other, if the gradation levels of the image pixels A1 and A2 are the same, the image pixels A1 and A2 expressed by the same panel pixel a1 will be perceived by the observer with approximately the same brightness.

Note that, although the unit period f2, which is a shift period, has been described as an example, the same applies to the unit periods f4, f6, and f8, which are other shift periods.

In the first embodiment, one panel pixel expresses eight video pixels, but four video pixels among the eight video pixels are visually recognized in the unit periods f2, f4, f6, and f8, which are shift periods, and thus it is not necessary to drive the optical path shifting element 230 at a high speed.

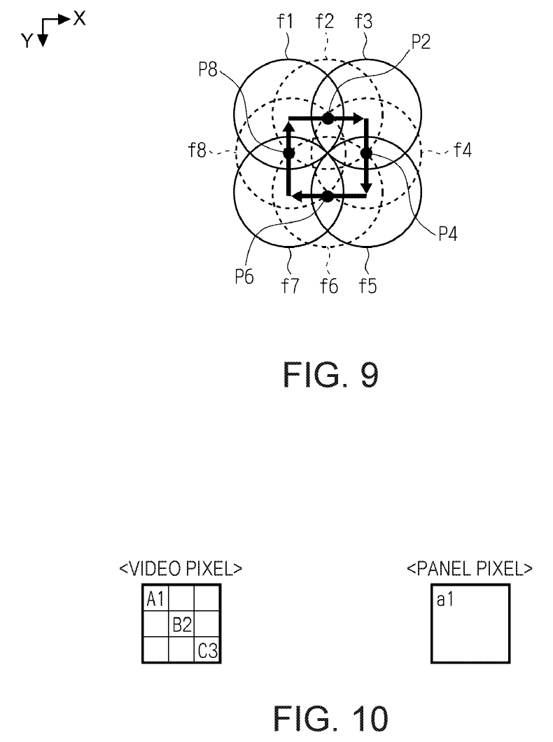

FIG. 9 is a diagram illustrating panel pixels visually recognized by an observer in the unit periods f1 to f8 of the frame (1F) period in the first embodiment. For the sake of explanation, the vertical and horizontal scales in FIG. 9 are enlarged compared to those in FIG. 7.

In the unit periods f1, f3, f5, and f7, the positions of the projection pixels are stagnant, and therefore, the panel pixels are visually recognized at the positions indicated the solid line in FIG. 9.

The unit periods f2, f4, f6, and f8 are shift periods, and the panel pixels are visually recognized at the positions where the lamp unit 2102 increases the light, that is, at the period centers P2, P4, P6, and P8, and which are the positions indicated in broken line.

Therefore, in the present embodiment, one panel pixel a1 displays eight video pixels A1, A2, A3, B3, C3, C2, C1, and B1 at the projection positions corresponding to the video pixels, and thus the resolution is enhanced in a pseudo manner. Since the lamp unit 2102 is in the turned-off state immediately after the start of a shift period and immediately before the end of a shift period, the video pixel expressed in a shift period will not be in a state of being visually recognized while superimposed with the video pixel before and after the projection position stagnates being visually recognized. Therefore, according to the present embodiment, it is possible to increase the resolution of the image to be visually recognized without degrading the display quality.

The modes of turning off and increasing the light in the unit periods f2, f4, f6, and f8 are not limited to those in FIG. 8. That is, in the unit periods f2, f4, f6, and f8, the light may be reduced or turned off at the start point and the end of each unit period, and the light may be increased near the center, so that the luminance of the temporal average value may be substantially equal in the unit periods f1 to f8.

In the first embodiment, the center video pixel of the 3 × 3 video pixels is not expressed by the panel pixel, and thus is in a state of missing from the display. However, in the first embodiment, for example, when the panel pixel a1 expresses the video pixels A1, A2, A3, B3, C3, C2, C1, and B1 at the projection positions corresponding to the image pixels, the image pixels overlap each other. This overlap causes the video pixel to be visually recognized as if it were the center video pixel of the 3 × 3 image, and therefore, in reality, is not visually recognized as if the video pixel were missing.

Next, a projection display device 1 according to a second embodiment will be described. The second embodiment is different from the first embodiment mainly in the following points. Specifically, the second embodiment is different from the first embodiment in, first, the configuration of the unit period in one frame (1F) period, second, the video pixel expressed by the panel pixel in the unit period, third, the projection position in the unit period, and, fourth, the control of the lamp unit 2102, while other aspects are substantially the same as those of the first embodiment.

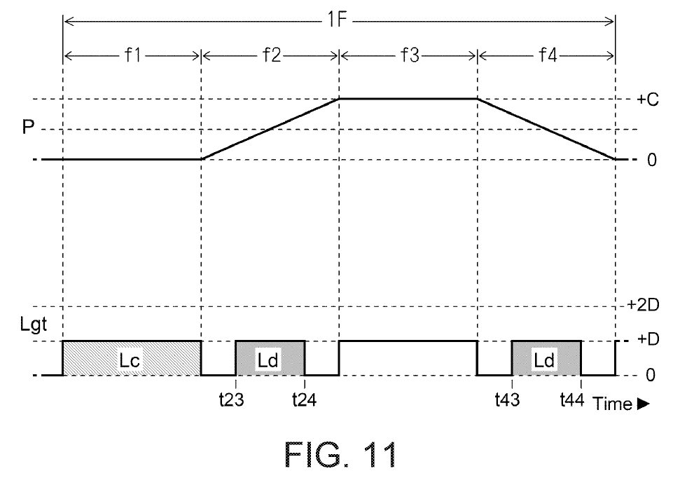

FIG. 10 is a diagram for explaining a correspondence relationship between video pixels and panel pixels in the projection display device 1 according to the second embodiment. FIG. 11 is a diagram for explaining the projection position and the control of the lamp unit 2102 in the unit periods f1 to f4 in the second embodiment.

In the second embodiment, as shown in FIG. 10, one frame (1F) period is divided into four periods of f1, f2, f3, and f4 in the order of time. The optical path shifting element 230 in the second embodiment is, in contrast to the two axis shift type of the first embodiment, in the second embodiment a one axis shift type, which shifts the projection position along a W direction, which is obtained by rotating the X direction clockwise by 45 degrees, and along a direction opposite to the W direction.

In the second embodiment, when the level of the control signal P is zero, the position of the projection pixel formed by the optical path shifting element 230 is the reference position in the unit period f1. When the level of the control signal P is +C, the position of the projection pixel is shifted from the reference position in the obliquely lower right direction by (2 √ 2/3) pixels in terms of panel pixels.

In the second embodiment, the control signal P is constant at zero in the unit period f1 as shown in FIG. 11. Therefore, the position of the projection pixel stagnates at the reference position in the unit period f1.

The control signal P starts to rise from zero at the start timing of the unit period f2 and reaches +C at the end timing of the unit period f2. Therefore, the position of the projection pixel starts to shift from the reference position in the obliquely lower right direction in the drawing at the start timing of the unit period f2, and reaches a position shifted from the reference position in the obliquely lower right direction by (2 √ 2/3) pixels in terms of panel pixels at the end timing of the unit period f2.

The control signal P is constant at +C in the unit period f3. Therefore, in the unit period f3, the position of the projection pixel is stagnant at the position at the end timing of the unit period f3.

The control signal P starts to decrease from +C at the start timing of the unit period f4, and reaches zero at the end timing of the unit period f4. Therefore, at the start timing of the unit period f4, the position of the projection pixel starts shifting in the upper leftward direction in the drawing from the stagnation position of the unit period f3 and, at the end timing of the unit period f4, returns from the stagnation position of the unit period f3 to the position shifted by (2 √ 2/3) pixels, in terms of panel pixels, in the upper leftward direction, that is, returns to the reference position.

In the second embodiment, the panel pixel a1 expresses the video pixel A1 in the unit period f1. On the other hand, in the unit period f1, the projection position stagnates at the reference position, and the control signal Lgt is constant at +D. Therefore, the video pixel A1 expressed by the panel pixel a1 in the unit period f1 is visually recognized by the observer at the reference position.

Similarly, the panel pixel a1 expresses the video pixel C3 in the unit period f3. On the other hand, in the unit period f3, the projection position stagnates at a position shifted from the reference position in the obliquely lower right direction by (2 √ 2/3) pixels in terms of panel pixels, and the control signal Lgt is constant at +D. Therefore, the video pixel C3 expressed by the panel pixel a1 in the unit period f3 is visually recognized by the observer at the position.

In the second embodiment, the panel pixel a1 expresses the video pixel B2 in the unit periods f2 and f4.

On the other hand, the position of the projection pixel shifts from the reference position to the stagnation position in the unit period f3 in the unit period f2, and shifts from the stagnation position in the unit period f3 to the reference position in the unit period f4.

In the unit period f2, the control signal Lgt is at zero from the start timing to the timing t23, is at +D from the timing t23 to the timing t24, and is at zero from the timing t24 to the end timing. In the unit period f4, the control signal Lgt is at zero from the start timing to the timing t43, is at +D from the timing t43 to the timing t44, and is at zero from the timing t44 to the end timing.

In the unit periods f2 and f4, the period length in which the level of the control signal Lgt is +D is 1/2 of the period length of the unit periods f2 and f4.

The area that is the product of the period length in the unit periods f1 and f3 multiplied by +D, which is the level of the control signal Lgt, is denoted by Lc. Assuming that the area in the unit period f2 or f4 obtained by multiplying the period length in which is the level of the control signal Lgt is +D by the level of +D is denoted by Ld, then the area Lc is equal to twice the area Ld.

In the unit periods f2 and f4, the panel pixel a1 expresses the video pixel B2 twice when the projection position is near the middle between the reference position and the position of the unit period f3.

Therefore, if the gradation level is the same, the video pixel B2 expressed by the panel pixel a1 is visually recognized by the observer at a position near the middle between the reference position and the position of the unit period f3 with the same luminance as the video pixel A1 expressed by the unit period f1 and the video pixel C3 expressed by the unit period f3.

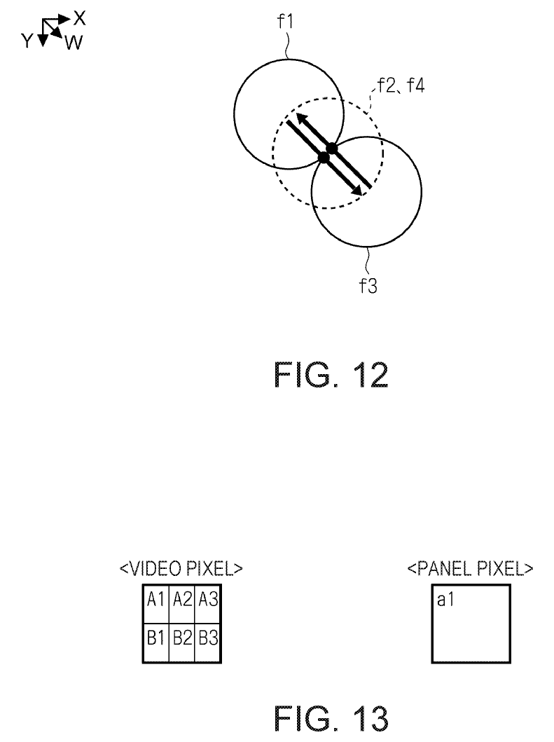

FIG. 12 is a diagram illustrating panel pixels visually recognized by an observer in the unit periods f1 to f4 of one frame (F1) period in the second embodiment. For the sake of explanation, the vertical and horizontal scales in FIG. 12 are enlarged compared to those in FIG. 10.

Since the projection position is stagnant in the unit periods f1 and f3, the panel pixel is visually recognized at the position indicated in solid line in the drawing.

The unit periods f2 and f4 are shift periods, and the panel pixels are visually recognized at positions where the lamp unit 2102 is turned on, that is, at positions indicated in broken line.

Therefore, in the second embodiment, one panel pixel a1 expresses three video pixels A1, B2, and C3 at the projection positions corresponding to the video pixels, respectively, and thus the resolution is enhanced in a pseudo manner. Since the lamp unit 2102 is in the turned-off state immediately after the start of a shift period and immediately before the end of a shift period, the video pixel expressed in a shift period will not be in a state of being visually recognized while superimposed with the video pixel before and after the projection position stagnates being visually recognized. Therefore, according to the second embodiment, although the resolution that is visually recognized in a pseudo manner is slightly reduced as compared with the first embodiment, it is possible to increase the display quality without reducing the display quality.

In the second embodiment, one panel pixel expresses three image pixels, and one of the video pixels is visually recognized in the unit periods f2 and f4, which are shift periods, and thus the optical path shifting element 230 does not need to be driven at high speed.

Next, a projection display device 1 according to a third embodiment will be described. The third embodiment is different from the first embodiment mainly in the following points. Specifically, the third embodiment is different from the first embodiment in, first, the configuration of the unit period in one frame (1F) period, second, the video pixel expressed by the panel pixel in the unit period, third, the projection position in the unit period, and, fourth, the control of the lamp unit 2102, and other aspects are substantially the same as those of the first embodiment.

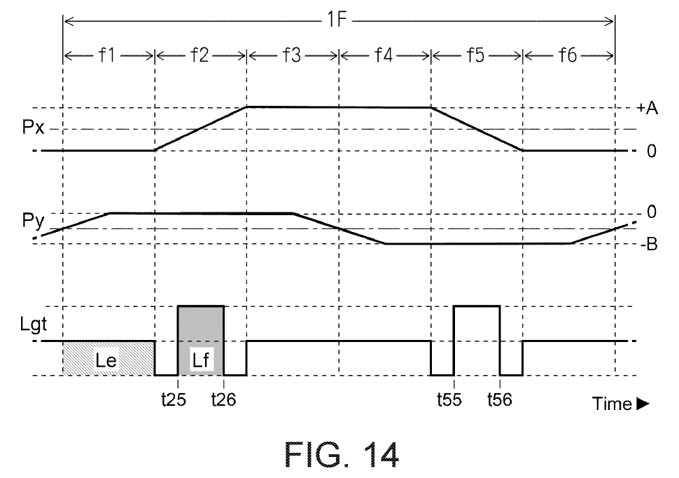

FIG. 13 is a diagram for explaining a correspondence relationship between the video pixels and the panel pixels in the projection display device 1 according to the third embodiment. FIG. 14 is a diagram for explaining the projection position and the control of the lamp unit 2102 in the unit periods f1 to f6 in the third embodiment.

In the third embodiment, as shown in FIG. 14, one frame (1F) period is divided into six periods of f1, f2, f3, f4, f5, and f6 in order of time.

The optical path shifting element 230 in the third embodiment is a two axis shift type similarly to the first embodiment. In the third embodiment, when the levels of the control signals Px and Py are both zero, the projection position by the optical path shifting element 230 is the reference position. In the third embodiment, when the level of the control signal Px is +A, the optical path shifting element 230 shifts the projection position in the rightward direction across the projection surface from the reference position by 2/3 of a pixel in terms of panel pixels and, when the level of the control signal Py is -B, shifts the projection position in the downward direction across the projection surface from the reference position by 1/2 of a pixel in terms of panel pixels.

In the third embodiment, as illustrated in FIG. 14, the control signal Px is constant at zero in the unit period f1, and the control signal Py rises from -B/2 at the start timing, reaches zero at an intermediate timing, and becomes constant.

Therefore, at the start timing of unit period f1, the position of the projection pixel shifts downward direction from the reference position by 1/4 pixel in terms of panel pixels, reaches the reference position at the intermediate timing of unit period f1, and stagnates at the reference position in the second half period of the unit period f1.

In the unit period f2, the control signal Px rises from zero to +A, and the control signal Py is constant at zero. Therefore, the position of the projection pixel shifts in the rightward direction from the reference position in the unit period f2. Specifically, the projection position reaches a position shifted by 2/3 pixels in terms of panel pixels in the rightward direction from the reference position in the unit period f2.

In the unit period f3, the control signal Px is constant at +A, and the control signal Py is constant at zero in the first half period, starts to decrease at the intermediate timing, and reaches -B/2 at the end timing.

Therefore, the position of the projection pixel stagnates at a position shifted by 2/3 pixels in terms of panel pixels in the rightward direction from the reference position in the first half period of the unit period f3. The position of the projection pixel starts to shift downward at the intermediate timing of the unit period f3 and, at the end timing of the unit period f3, reaches a position shift in the downward direction from the stagnation position of the unit period f3 by 1/4 pixel in terms of panel pixels.

In the unit period f4, the control signal Px is constant at +A, and the control signal Py decreases from -B/2 at the start timing, reaches -B at the intermediate timing, and becomes constant.

Therefore, the position of the projection pixel continues from the unit period f3 to shift in the downward direction in the first half period of the unit period f4, reaches a position shift at the intermediate timing that is 1/2 pixel, in terms of panel pixels, in the downward direction from the stagnation position of the unit period f3, and in the second half period stagnates at the reached position.

In the unit period f5, the control signal Px decreases from +A to zero, and the control signal Py is constant at -B. Therefore, the position of the projection pixel is shifted in the leftward direction from the stagnation position in the unit period f4. Specifically, in the unit period f5, the projection position reaches a position that is separated in the leftward direction from the stagnation position in the unit period f4 by 2/3 pixels, in terms of panel pixels.

In the unit period f6, the control signal Px is constant at zero, and the control signal Py is constant at -B in the first half period, starts to rise at an intermediate timing, and reaches -B/2 at the end timing.

Therefore, in the first half period of the unit period f6, the position of the projection pixel stagnates at a position separated in the leftward direction from the stagnation position of the unit period f3 by 2/3 pixels in terms of panel pixels. The position of the projection pixel starts shifting in the upward direction at the intermediate timing of the unit period f6 and, at the end timing of the unit period f6, reaches a position shifted upward direction by 1/4 pixel in terms of panel pixels from the stagnation position of the unit period f6. That is, the pixel at the projection position returns to the position at the start timing of the unit period f1 at the end timing of the unit period f6.

According to the third embodiment, in the unit periods f1, f2, f3, f4, f5, and f6, the panel pixel a1 is expressed as the video pixels A1, A2, B3, B2, and B1 in this order. The position of the projection pixel stagnates in the second half period of the unit period f1, the first half period of the unit period f3, the second half period of the unit period f4, and the first half period of the unit period f6 among the unit periods f1 to f6. In the first half period of the unit period f1, the second half period of the unit period f3, the first half period of the unit period f4, and the second half period of the unit period f6, the position of the projection pixel is shifted upward or downward, but the shift amount is smaller than that in the unit periods f2 and f5.

Therefore, in the third embodiment, the panel pixel a1 in the unit periods f1, f3, f5, and f7 may be said to express the video pixels A1, A3, C3, and C1 in this order at the stagnation position.

The panel pixel a1 in the unit period f2 expresses the video pixel A2, but is close to the position of the unit period f1 immediately after the start of the unit period f2, and is close to the position of the unit period f3 immediately before the end of the unit period f2.

In the unit period f2, the control signal Lgt is at zero from the start timing to the timing t25, is at +2D from the timing t25 to the timing t26, and is at zero from the timing t25 to the end timing. In the unit period f5, the control signal Lgt is at zero from the start timing to the timing t55, is at +2D from the timing t55 to the timing t56, and is at zero from the timing t56 to the end timing.

In the unit periods f2 and f5, the period length in which the level of the control signal Lgt is +2D is 1/2 of the period length of the unit periods f2 and f5.

An area that is a product of the period length in the unit periods f1, f3, f4, or f6 multiplied by +D, which is the level of the control signal Lgt, is denoted by Le. In the unit period f2 or f5, assuming that Lf is the area obtained by multiplying a period length in which the level of the control signal Lgt is +2D by the level of +2D, then the area Le and the area Lf are in an equal relationship.

Therefore, if the gradation of the video pixels A1 and A2 are the same, the video pixels A1 and A2 expressed by the same panel pixel a1 are visually recognized by the observer with substantially the same brightness.

Although the unit period f2, which is a shift period, has been described as an example, the same applies to the unit period f5, which is another shift period.

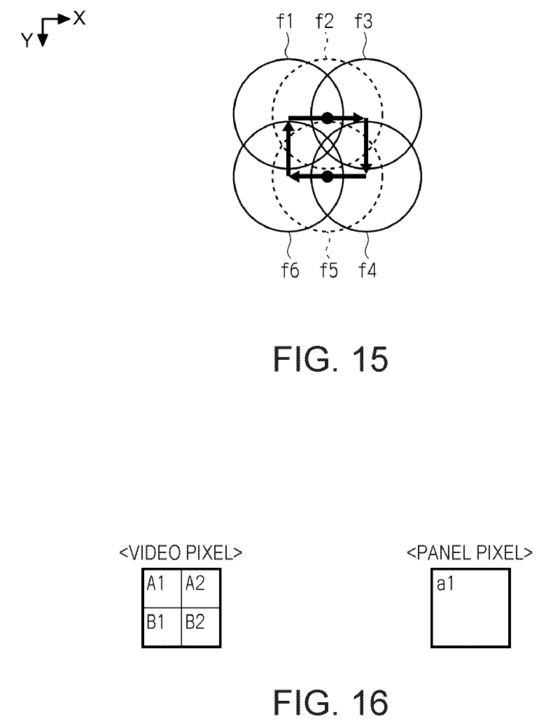

FIG. 15 is a diagram illustrating panel pixels visually recognized by an observer in the unit periods f1 to f6 of the frame (F1) period in the third embodiment. For the sake of explanation, the vertical and horizontal scales in FIG. 15 are enlarged compared to those in FIG. 13.

In the unit periods f1, f3, f4, and f5, the positions of the projection pixels are substantially stagnant, and therefore, the panel pixels are visually recognized at the positions indicated in solid line in FIG. 15.

The unit periods f2 and f5 are shift periods, and the panel pixel is visually recognized at a position where the lamp unit 2102 increases the light, that is, a position indicated in broken line.

Therefore, in the third embodiment, one panel pixel a1 displays six video pixels A1, A2, A3, B3, B2, and B1 at the projection positions corresponding to the video pixels, and thus the resolution is enhanced in a pseudo manner. Since the lamp unit 2102 is in the turned-off state immediately after the start of a shift period and immediately before the end of a shift period, the video pixel expressed in a shift period will not be in a state of being visually recognized while superimposed with the video pixel before and after the projection position stagnates being visually recognized. Therefore, according to the third embodiment, the resolution of the image to be visually recognized can be increased without degrading the display quality.

In the third embodiment, one panel pixel expresses six image pixels, but two of the video pixels are visually recognized in the unit periods f2 and f5, which are shift periods, and thus the optical path shifting element 230 does not need to be driven at high speed.

In the third embodiment, the resolution is increased three times in the X direction and twice in the Y direction in a pseudo manner, however the resolution may be increased twice in the X direction and three times in the Y direction in a pseudo manner.

For example, the following aspects are understood from the embodiments illustrated above.

A projection display device according to a first aspect includes: a light source that emits light; a liquid crystal panel having a panel pixel and configured to receive light emitted from the light source; an optical path shifting element that shifts an optical path of projection light emitted from the liquid crystal panel to change a position of a projection pixel projected from the panel pixel; and a display control circuit that controls the liquid crystal panel and the optical path shifting element, wherein video data is constituted by pixel data; the display control circuit causes the optical path shifting element to shift the position of the projection pixel from a first position to a second position in one frame period and supplies, to the panel pixel, a data signal corresponding to a gradation level designated by the pixel data, sets pixel data corresponding to the data signal to first pixel data that corresponds to the first position in a period in which the position of the projection pixel is the first position, second pixel data that corresponds to the second position in a period in which the position of the projection pixel is the second position, and third pixel data that is located between the first pixel data and the second pixel data in a period in which the position of the projection pixel is shifted from the first position to the second position via a first section including a third position, and causes the light source to turn off or reduce light in a period in which the position of the projection pixel is from the first position to a start point of the first section, illuminate the projection pixel with a luminance higher than a reduced light in a period in which the position of the projection pixel is in the first section, and turn off or reduce light in a period in which the position of the projection pixel is located between the end point of the first section and the second position.

According to the projection display device of the first aspect, the panel pixel expresses the first pixel data when the position of the projection pixel is the first position, expresses the third pixel data in the shift period from the first position to the second position, and expresses the second pixel data when the position of the projection pixel is the second position. In the shift period in which the panel pixel expresses the third pixel data, the light source is turned on in the first section in which the projection position includes the third position, and the light source is turned off or reduced in the other period, and therefore, the panel pixel is visually recognized when the projection position is in the first section including the third position, but the panel pixel is not visually recognized or is hardly visually recognized when the projection position is in a section other than the first section. Therefore, the third pixel data between the first pixel data and the second pixel data is visually recognized at a correct position, and thus the resolution can be increased in a pseudo manner.

Since it is not necessary to shift the projection position for each unit period and it is not necessary to drive the optical path shifting element at a high speed, it is possible to enhance the resolution in a pseudo manner without causing an increase in the cost of the device, an increase in the size of the device, or the like.

The lamp unit 2102 is an example of a "light source", the reference position is an example of a "first position", and in the first embodiment, the stagnation position of the unit period f3 is an example of a "second position", and the midpoint point between the stagnation position of the unit period f1 and the stagnation position of the unit period f3 is an example of a "third position".

In the unit period f2, the timing t21 is an example of "the start of the first section", the timing t22 is an example of "the end of the first section", and the section in which the projection position is shifted in the period from the timing t21 to the timing t22 is an example of "the first section".

The video pixel A1 is an example of a "first pixel data", the video pixel A3 is an example of a "second pixel data", and the video pixel A2 is an example of a "third pixel data".

In the present description, "turn off" means that the luminance of light emitted from the light source is set to zero, specifically, the light source is turned off, and “reduce light" means that the luminance of light emitted from the light source is set to be lower than that in the immediately preceding state.

In the projection display device according to a second specific aspect of the first aspect, the display control circuit causes the optical path shifting element to shift an optical path of the projection light in a first direction and in a second direction that intersects the first direction and assuming that the first position, the third position, and the second position are arranged in the first direction, shift the position of the projection pixel from the second position to a fourth position, sets pixel data corresponding to the data signal to fourth pixel data corresponding to the fourth position in a period in which the position of the projection pixel is the fourth position and fifth pixel data located between the second pixel data and the fourth pixel data in a period in which the position of the projection pixel is shifted from the second position to the fourth position via a second section including a fifth position, and causes the light source to turn off or reduce light in a period in which the position of the projection pixel is located between the second position and the start point of the second section, illuminate the projection pixel with a luminance higher than a reduced light in a period in which the position of the projection pixel is in the second section, and turn off or reduce light in a period in which the position of the projection pixel is located between the end point of the second section and the fourth position.

According to the projection display device of the second aspect, it is possible to increase the resolution in a pseudo manner not only in the first direction but also in the second direction.

The X direction is an example of a "first direction", and the Y direction is an example of a "second direction". In the first embodiment, the stagnation position of the unit period f5 is an example of a "fourth position", and the midpoint between the stagnation position of the unit period f3 and the stagnation position of the unit period f5 is an example of a "fifth position". In the unit period f4, the timing t41 is an example of "the start of the second section", the timing t42 is an example of "the end of the second section", and the section in which the projection position is shifted in the period from the timing t41 to the timing t42 is an example of "the second section".

The video pixel C3 is an example of a "fourth pixel data", and the video pixel B3 is an example of a "fifth pixel".

In the projection display device according to another third specific aspect of the first aspect, the display control circuit causes the optical path shifting element to shift an optical path of the projection light in a third direction intersecting a first direction and a second direction intersecting the first direction, and the first position, the third position, and the second position are arranged along the third direction.

According to the projection display device of the third aspect, it is possible to increase the resolution in the third direction intersecting the first direction and the second direction in a pseudo manner. The W direction is an example of a "third direction".

In the projection display device according to another fourth specific aspect of the first aspect, the display control circuit causes the optical path shifting element to shift an optical path of the projection light in a first direction and in a second direction that intersects the first direction and the first position, the third position, and the second position are arranged along either the first direction or the second direction.

According to the projection display device of the fourth aspect, it is possible to increase the resolution in either the first direction or the second direction in a pseudo manner.

In the projection display device according to another fifth specific aspect of the first aspect, the display control circuit causes the light source to make luminance in a period in which the position of the projection pixel is in the first section higher than the luminance when the position of the projection pixel in the first position or the second position.

In the projection display device according to another sixth specific aspect of the first aspect, the display control circuit causes the light source to make luminance in a period in which the position of the projection pixel is from the first position to the start point of the first section and in a period in which the position of the projection pixel is from the end point of the first section to the second position lower than the luminance when the position of the projection pixel is in the first position or the second position.

In the projection display device according to another seventh specific aspect of the first aspect, the display control circuit causes the light source to make luminance in a period in which the position of the projection pixel is in the first section higher than luminance when the position of the projection pixel is in the first position or the second position and make luminance in a period in which the position of the projection pixel is from the first position to the start point of the first section and in a period in which the position of the projection pixel is from the end point of the first section to the second position lower than the luminance when the position of the projection pixel is in the first position or the second position.

What is claimed is:

1. A projection display device, comprising:
a light source configured to emit light;
a liquid crystal panel having a panel pixel and configured to receive light emitted from the light source;
an optical path shifting element configured to shift an optical path of projection light emitted from the liquid crystal panel to change a position of a projection pixel projected from the panel pixel; and
a display control circuit configured to control the liquid crystal panel and the optical path shifting element, wherein
video data is constituted by pixel data;
the display control circuit is configured to:
cause the optical path shifting element to shift the position of the projection pixel from a first position to a second position in one frame period and
supply, to the panel pixel, a data signal corresponding to a gradation level designated by the pixel data;
set pixel data corresponding to the data signal to
first pixel data that corresponds to the first position in a period in which the position of the projection pixel is the first position,
second pixel data that corresponds to the second position in a period in which the position of the projection pixel is the second position, and
third pixel data that is located between the first pixel data and the second pixel data in a period in which the position of the projection pixel is shifted from the first position to the second position via a first section including a third position; and
cause the light source to
turn off or reduce light in a period in which the position of the projection pixel is from the first position to a start point of the first section,
illuminate the projection pixel with a luminance higher than a reduced light in a period in which the position of the projection pixel is in the first section, and
turn off or reduce light in a period in which the position of the projection pixel is located between an end point of the first section and the second position.

2. The projection display device according to claim 1, wherein
the display control circuit is configured to:
cause the optical path shifting element to
shift an optical path of the projection light in a first direction and in a second direction that intersects the first direction, and
assuming that the first position, the third position, and the second position are arranged in the first direction, shift the position of the projection pixel from the second position to a fourth position;
set pixel data corresponding to the data signal to
fourth pixel data corresponding to the fourth position in a period in which the position of the projection pixel is the fourth position, and
fifth pixel data located between the second pixel data and the fourth pixel data in a period in which the position of the projection pixel is shifted from the second position to the fourth position via a second section including a fifth position; and
cause the light source to
turn off or reduce light in a period in which the position of the projection pixel is located between the second position and a start point of the second section,
illuminate the projection pixel with a luminance higher than a reduced light in a period in which the position of the projection pixel is in the second section, and
turn off or reduce light in a period in which the position of the projection pixel is located between an end point of the second section and the fourth position.

3. The projection display device according to claim 1, wherein
the display control circuit is configured to:
cause the optical path shifting element to
shift an optical path of the projection light in a third direction intersecting a first direction and a second direction intersecting the first direction,
wherein the first position, the third position, and the second position are arranged along the third direction.

4. The projection display device according to claim 1, wherein
the display control circuit is configured to:
cause the optical path shifting element to
shift an optical path of the projection light in the first direction and the second direction,
wherein the first position, the third position, and the second position are arranged along either the first direction or the second direction.

5. The projection display device according to claim 1, wherein
the display control circuit is configured to:
cause the light source to
make a luminance in a period in which the position of the projection pixel is in the first section
higher than a luminance when the position of the projection pixel in the first position or the second position.

6. The Projection display device according to claim 1, wherein
the display control circuit is configured to:
cause the light source to
make a luminance in a period in which the position of the projection pixel is from the first position to the start point of the first section and in a period in which the position of the projection pixel is from the end point of the first section to the second position
lower than a luminance when the position of the projection pixel is in the first position or the second position.

7. The projection display device according to claim 1, wherein
the display control circuit is configured to:
cause the light source to
make a luminance in a period in which the position of the projection pixel is in the first section
higher a luminance when the position of the projection pixel is in the first position or the second position, and
make a luminance in a period in which the position of the projection pixel is from the first position to the start point of the first section and in a period in which the position of the projection pixel is from the end point of the first section to the second position
lower than the luminance when the position of the projection pixel is in the first position or the second position.
